(19) United States
(12) Patent Application Publication
(10) Pub. No.: US 2024/0355233 A1
(43) Pub. Date: Oct. 24, 2024

(54) SURGICAL ANASTOMOSIS SIMULATION TRAINOR

(71) Applicants: Laura Lynn DONAHOE, Mississauga (CA); Kazuhiro YASUFUKU, Toronto (CA); Katsiaryna KAZLOVICH, Toronto (CA); Margaret Blair MARSHALL, Boston, MA (US)

(72) Inventors: Laura Lynn DONAHOE, Mississauga (CA); Kazuhiro YASUFUKU, Toronto (CA); Katsiaryna KAZLOVICH, Toronto (CA); Margaret Blair MARSHALL, Boston, MA (US)

(21) Appl. No.: 18/645,029

(22) Filed: Apr. 24, 2024

Related U.S. Application Data
(60) Provisional application No. 63/461,529, filed on Apr. 24, 2023.

(51) Int. Cl. G09B 23/34

(52) U.S. Cl. CPC G09B 23/34

(57) ABSTRACT

Present invention relates to techniques and process of developing and testing a take-home surgical anastomosis simulation model. Through an iterative process, a simulation model was custom designed to target specific skill development and performance objectives that focused on anastomotic techniques in thoracic surgery and consisted of 3D printed and silicone molded components. Various manufacturing techniques such as silicone dip spin coating and injection molding techniques have been explored as part of the research and development process. The final prototype is a low-cost, take-home model with reusable and replaceable components.

### CROSS-REFERENCE TO RELATED APPLICATION

This application claims the benefit of U.S. Provisional Application No. 63/461,529, titled “SURGICAL ANASTOMOSIS SIMULATION TRAINOR”, and filed on Apr. 24, 2023. The entire content of which is incorporated herein by reference.

### FIELD

The present disclosure generally relates to the field of surgical training tools and in particular anastomoses simulation and training tools.

### BACKGROUND

Traditional surgical education is changing at a rapid pace. This shift has been influenced by the widespread adoption and availability of rapid manufacturing methods, such as 3D printing, and ever-evolving analytical methods for data acquisition and processing. Since the declaration of the COVID-19 global pandemic, the modern approach to on-site skill development has had to evolve to accommodate limited access to training due to the risk of exposure and scarcity of resources. In many ways, these changes serve as a catalyst for innovation, such as the concept of virtual technical skills education.

### SUMMARY OF INVENTION

In one aspect, a kit for anastomoses simulation and training is provided, the kit comprising: an open box having a perimeter wall and a base defining an interior space, the perimeter wall having a plurality of anchor points; one or more tubing for simulation of a tubular bodily vessel; a plurality of coupling means configured to couple to the plurality of anchor points and to suspend the one or more tubing within the interior space from a first anchor point to a second anchor point.

In another aspect, a method of manufacturing a silicone tracheal or bronchial segment is provided for use in anastomoses simulation and training, the silicone tracheal or bronchial segment having a tubular wall and a plurality of semi-circular rings disposed along one exterior side of the tubular wall, the method comprising: providing a mold based on a human tracheal or bronchial segment, the mold having a tracheal ring compartment and a bronchial wall compartment; providing a first silicone mixture and injection molding same into the tracheal ring compartment; curing the first silicone mixture; providing a second silicone mixture and injection molding same into the bronchial wall compartment with the cured first silicone mixture; and curing the second silicone mixture.

In another aspect, a silicone tracheal or bronchial segment is provided for use in anastomoses simulation and training.

### DESCRIPTION OF THE FIGURES

Embodiments of devices, apparatus, methods, and kits are described throughout reference to the drawings.

FIG. 1 shows components of the simulator. Components include a) mounting attachments, b) suture holding pads, c) the acrylic box, and d) a silicone bronchus and Penrose drains.

FIG. 2 shows an assembled simulation model.

FIG. 3 shows an acrylic box. A) An acrylic box with threaded metal inserts, B) an acrylic box with ¼″ magnet inserts.

FIG. 4 shows a suture holder. A) shows suture holder core modelled in Fusion360. The core is 3D printed with polylactic acid (PLA) or polyethylene terephthalate glycol (PETG) material; B) Shown is a 3D printed (PLA or PETG) molding tray used to manufacture silicone pads; C) Suture holder placement along the edge of the acrylic box.

FIG. 5 shows mounting pegs. A) Mounting pegs with threaded bases featuring large, medium, and small sizes, B) mounting pegs with magnetic bases featuring large, medium, and small sizes, and C) mounting pegs featuring liquid injection ports for water tightness testing.

FIG. 6A) Components of the silicone vessel injection molding negatives. All parts are designed in Fusion 360 and 3D printed with PLA and/or PETG. Shown disassembled, B) Assembled mold, C) Silicone vessel, D) Silicone vessel coated in wool and silicone blend by means of dip-spin-coating technique, E) Silicone vessel coated in multiple layers of varied strength silicone by means of dip-spin-coating technique.

FIG. 7 shows a trachea mold. A) 3D printed PLA and/or PETG negative mold disassembled. Front view of the trachea mold positive and negative components including negative shell, lid, and positive internal half-cylinder insert, B) assembled 3D printed negative for injection molding, C) the computer-aided design (CAD) for the trachea model, D) silicone trachea mounted inside the acrylic box with help of 3D printed pegs.

FIG. 8 shows a trachea cast with two-part silicone casting technique for flat back wall design and rigid trachea rings. A) Front view of the final trachea cast, B) the flat back wall of the trachea cast, and C) a top view of the trachea cast.

FIG. 9 shows user experience results.

FIG. 10 shows a quick release suture holder. A) a perspective view of a quick release suture holder modelled in Fusion360, B) shows quick release suture holder placement along the edge of the acrylic box, the suture holder shown is 3D printed and holds a silicone trachea mounted inside the acrylic box.

FIG. 11 shows an alternative design of the Stay Suture Holder shown in FIG. 4. A) is a perspective view of the suture holder as seen in Fusion 360, B) is a front view of the suture holder as seen in Fusion360.

FIG. 12 shows mounting pegs. A) mounting pegs featuring a diameter size of 28, 24 and 14 mm, and bottom row of mounting pegs featuring liquid injection ports for water tightness testing. B) 3D printed mounting pegs, the pegs in bottom row are fitted with the screw cap injection port that can be used to attach the Luer Lock Syringe to the peg.

FIG. 13 shows an assembled simulation model in use to show how the Luer Lock Syringe is attached to a mounting peg with a water channel to inject water into the vessel form.

FIG. 14 shows estimated-time-to-completion (ETC) results of anastomosis procedures performed by 5 participants over 10 training sessions using the anastomoses simulation kit described herein.

FIG. 15 shows performance checklist of 6 participants based on 7 parameters.

FIG. 16 shows another embodiment of a simulation model and its components.

### DETAILED DESCRIPTION

In 2020, present inventors implemented a virtual technical skills program during the pandemic when most clinic activity had ceased. The surgical fellows were provided with a bench model and surgical instruments and balloons were used as the vascular model due to the lack of availability of any other materials [1]. Drawing inspiration from this program, present inventors have developed and validated a portable module comprised of components with increasing difficultly to provide trainees with an opportunity to perfect complex vessel and airway anastomosis techniques. The intention of the module is to allow skilled trainees to further enhance and practice their vascular and bronchial anastomosis skills on their own time, outside of scheduled laboratories that are difficult to keep due to busy surgical schedules. Also, the model was designed to be free from animal parts so that it can be used in a multitude of settings. Thus, one goal of this project is to ensure that training accessibility and affordability are addressed with a tangible simulation tool. Herein, this paper outlines development, and testing of the surgical anastomosis simulation module and its user experience assessment and future directions.

The present inventors have developed a surgical simulation box model that can be used by surgical trainees to learn and practice anastomosis skills both in the hospital and at home. Currently, there are no commercially-available products for simulation of anastomosis used in thoracic surgery and lung transplantation. One intention of the module is to allow skilled trainees to further enhance and practice their vascular and bronchial anastomosis skills on their own time, outside of scheduled laboratories that are difficult to keep due to busy surgical schedules. Also, the model was designed to be free from animal parts so that it can be used in a multitude of settings. One goal of this model is to ensure that training accessibility and affordability are addressed with a tangible simulation tool. As there are no simulation models for thoracic surgery and lung transplantation, this simulation box can potentially be marketed to all thoracic and lung transplant training programs nationally and internationally.

Using an iterative design, the main features to be incorporated into the mounting box were defined as: 1) ability to attach and remove the multi-use anastomotic models to the box; 2) ability to change the complexity of the task through different sized anastomosis attachments, different depths at which the anastomosis can be performed, and different methods of anastomosis (i.e. end-to-end and end-to-side). Keeping these features in mind, the mounting box design consisted of a laser cut acrylic sheet and 3D printed components that were attached together with threaded metal screws and inserts. To achieve the desired shape, clear acrylic sheet was cut to measure and then heat molded into a box-like shape. Insert holes were drilled and metal inserts were pressed in the desired position. The mounting pegs were designed in Fusion360 and printed with Prusa i3 MK3S+ printer and 1.75 mm polylactic acid (PLA) filament. This process was designed to be scalable, budget friendly, and easily replicated to manufacture larger quantities of mounting pegs that can accommodate different sizes of Penrose tubes and silicone components.

### EXAMPLES

### Material and Methods

### Model Preparation

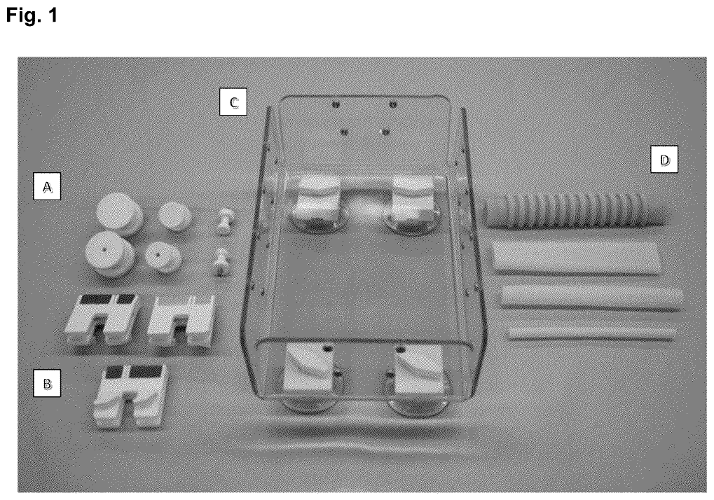

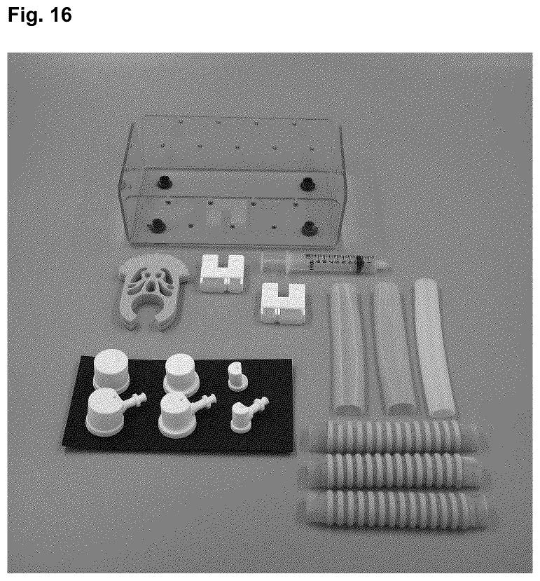

The design and manufacturing process for the anastomosis simulation module was broken down into three components. These include: 1) design and assembly of the mounting box with multi-functional mounting plates to adjust the complexity of the anastomosis model, 2) testing and comparison of materials used to mimic vascular anatomy and physical properties, 3) design, manufacturing, and assembly of a silicone bronchial segment (see FIGS. 1 and 16).

### Model Components: Mounting Box

In designing this model for take-home practice, the first component to be developed was the structure to hold the anastomotic models. Using an iterative design, the main features to be incorporated into the mounting box were defined as: 1) ability to attach and remove the multi-use anastomotic models to the box; 2) ability to change the complexity of the task through different sized anastomosis attachments, different depths at which the anastomosis can be performed, and different methods of anastomosis (i.e. end-to-end and end-to-side). Keeping these features in mind, the mounting box design consisted of a laser cut acrylic sheet and 3D printed components that were attached together with threaded metal screws and inserts. To achieve the desired shape, clear acrylic sheet was cut to measure and then heat molded into a box-like shape. Insert holes were drilled and metal inserts were pressed in the desired position. The mounting pegs were designed in Fusion360 and printed with Prusa i3 MK3S+ printer and 1.75 mm polylactic acid (PLA) filament. This process was designed to be scalable, budget friendly, and easily replicated to manufacture larger quantities of mounting pegs that can accommodate different sizes of Penrose tubes and silicone components.

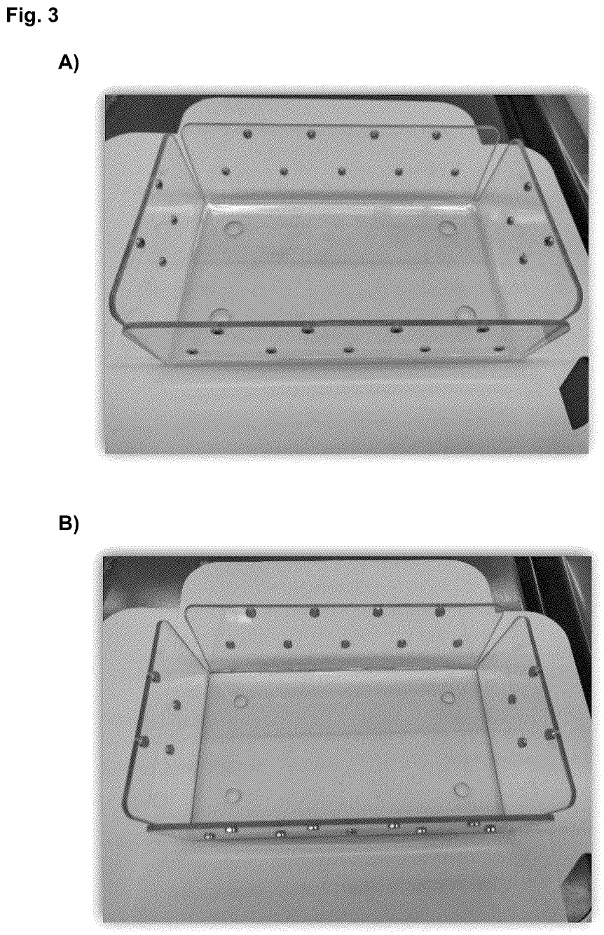

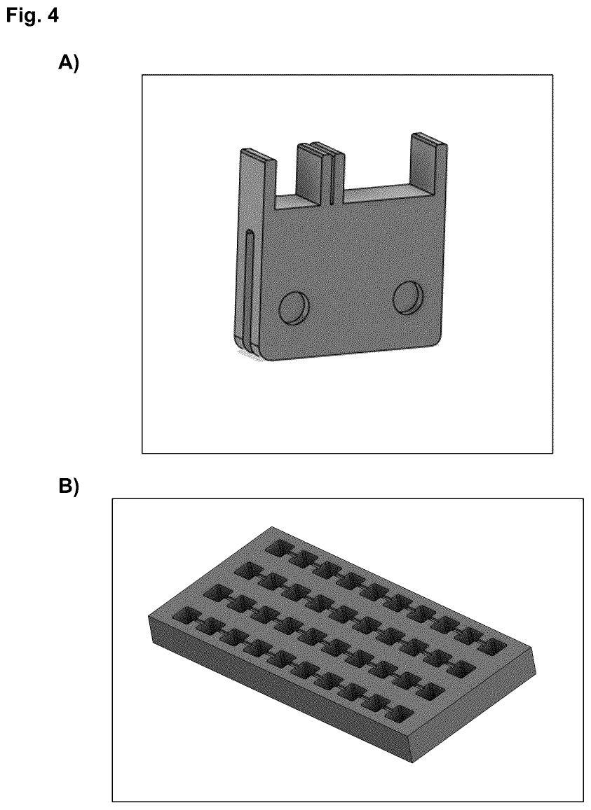

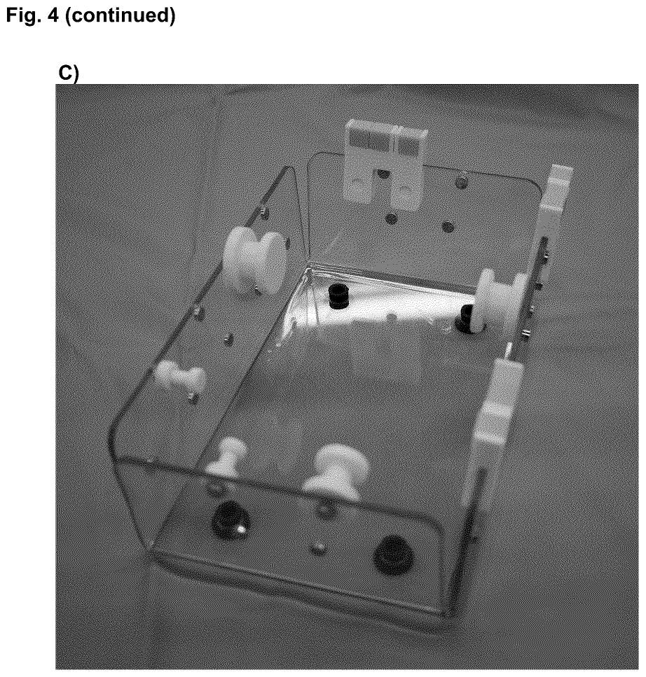

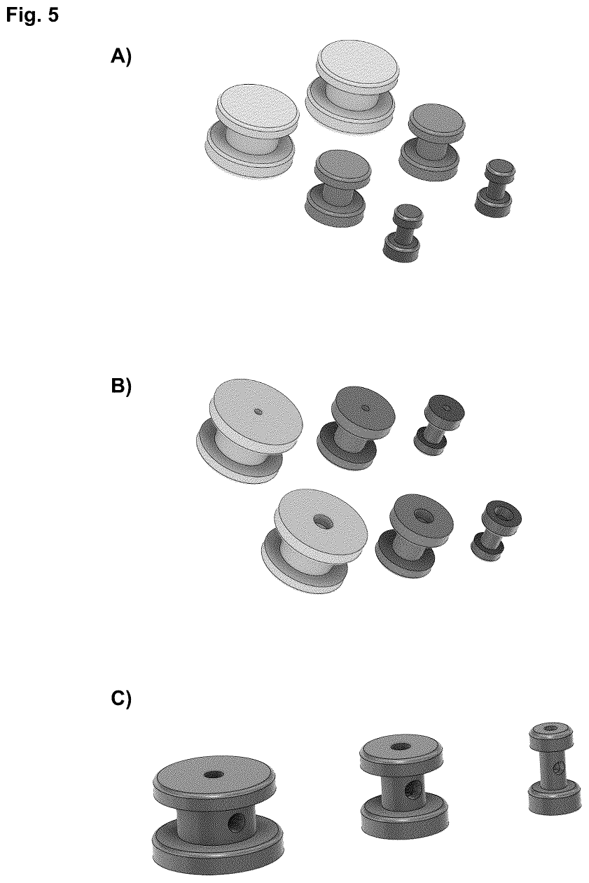

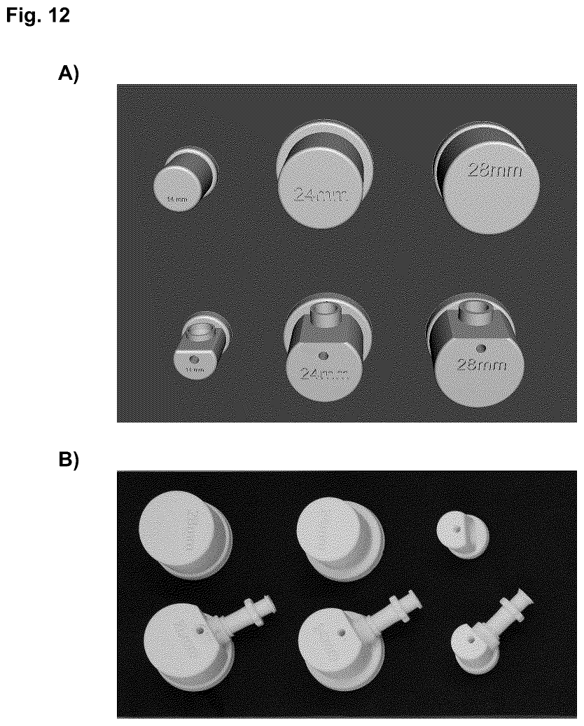

Another exemplary acrylic box with magnet inserts in the insert holes is shown in FIG. 3. Exemplary suture holders are shown in FIGS. 4, 10, and 11. Exemplary mounting pegs are shown in FIGS. 5 and 12.

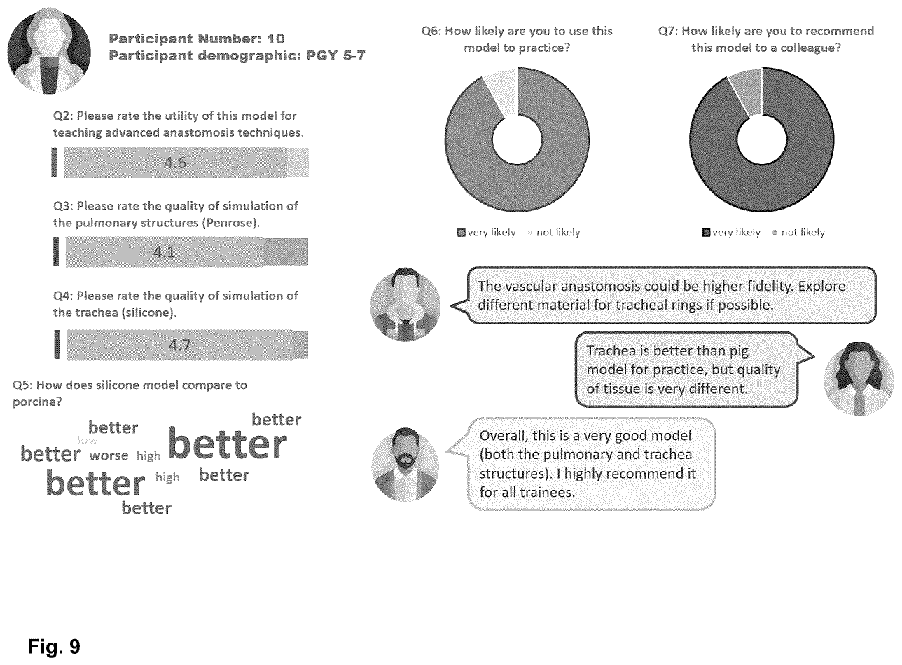

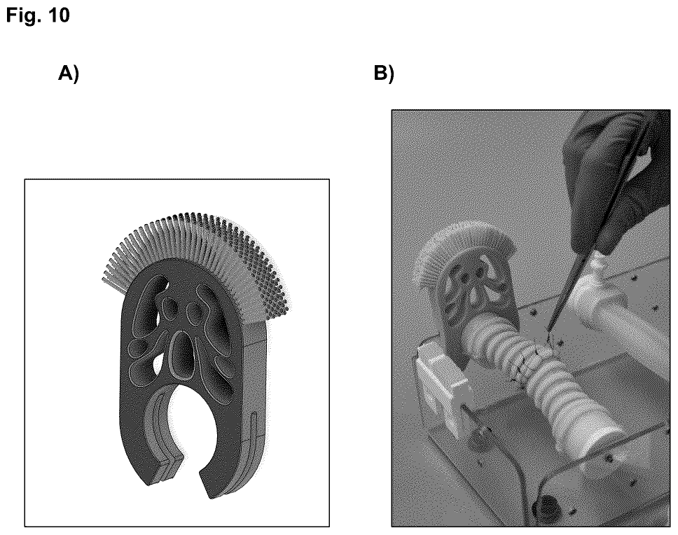

The exemplary suture holder shown in FIG. 10 is a quick release suture holder featuring bristles positioned along a semi-circular edge. The quick release suture holder is modelled in Fusion360, 3D printed on a PolyJet Stratasys J735 printer with a combination of Agilus30 and Vero materials. Agilus30 is an advanced PolyJet material designed for use in the creation of strong, flexible parts. PolyJet Vero Materials are rigid, opaque photopolymers. They can be blended with other photopolymers such as Agilus30, to create variations in hardness, flexibility, translucency, or heat resistance. The quick-release suture holder is designed featuring soft bristles that are used to secure the long end of the suture in place without tension while the surgeon is placing the following stitch. Mainly, it allows the surgeon to keep the long end of the suture out of the way and prevents the twisting of the sutures. In the operating room, this issue is typically avoided with the help of an assistant surgeon or surgical nurse. Since the kit is designed for individual training purposes, this suture holder was developed to allow trainees to practice anastomosis without assistance.

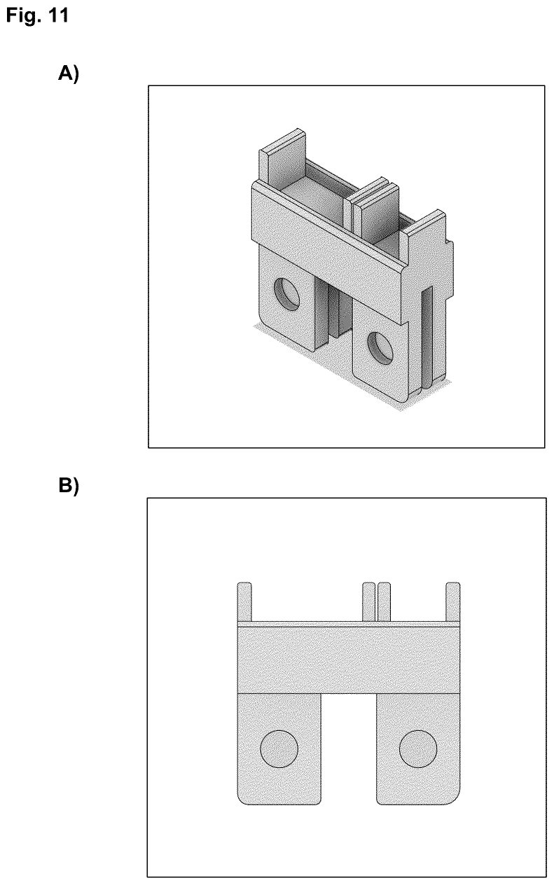

In one embodiment, a stay suture holder is provided featuring soft silicone pads (see FIG. 11). It is used to temporarily position or secure the sutures in place to allow for the manipulation of the surgical area while the user (i.e. surgeon) is focused on completing anastomosis of the back or front portion of the vessel or trachea.

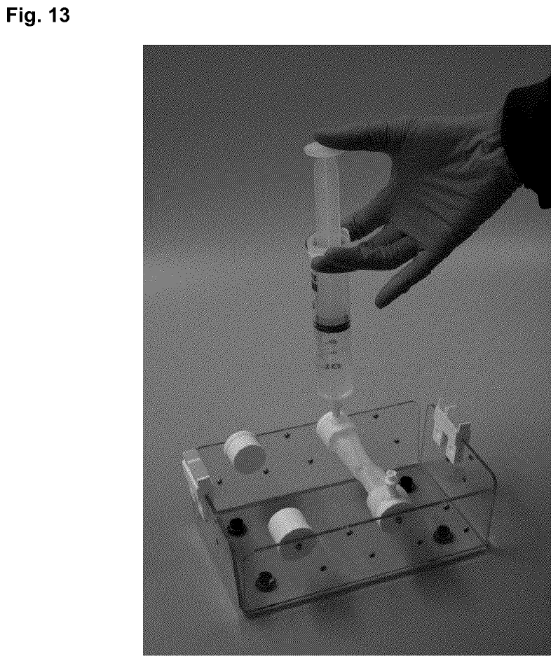

In some embodiments, the mounting pegs are 3D printed. The mounting pegs of FIG. 12 have been modified to accommodate for an integration of a wider water channel that can be used to test anastomosis for water tightness. Thus, allowing participants to independently evaluate the quality of the anastomosis. Presence of leaks indicates insufficient suture tension or inappropriate execution of the anastomosis technique. Absence of leaks indicates water-tight anastomosis. In one embodiment, solid mounting pegs are provided (see FIG. 12, A). In one embodiment, mounting pegs with the incorporated water channel are provided (see FIG. 12, A). In one embodiment, mounting pegs are fitted with the screw cap injection port that can be used to attach a Luer Lock Syringe to the pegs (see FIGS. 12 and 13). There are 3 sizes of pegs with 28, 24 and 14 mm diameter.

### Model Components: Vascular Material Testing

Vascular anastomosis is a commonly performed task in multiple surgical specialties, including cardiac surgery, vascular surgery, and transplant surgery. Often, commercially manufactured Penrose drains are used as the vessel model, but these are relatively low fidelity, in that the characteristics of the material do not exactly mirror the characteristics of real blood vessel walls [2]. To create a more realistic vascular and trachea model, we conducted a series of tests with 3D printed, cast and free-formed vessels and tracheas to identify which materials carry adequate resemblance suitable for identified training objectives.

To test materials, we used deposition and extrusion printing methods that include inkjet (Stratasys Inc.) and stereolithography (Formlabs) printers. The Stratasys printer and others like it can achieve high anatomic accuracy due to their capability to produce prints with water-soluble bases, facilitating the print of hollow vascular structures. These printers are ideal for complex and customizable shapes and have been widely implemented in the development of sophisticated training models, such as the congenital heart models designed and manufactured by 3DPrintHeart lab, led by Dr. Shi Joon Yo [3]. However, the softest mix of material used with such printers bears low resistance to tear, meaning that standard nylon sutures can pull through and damage the print under higher tension.

Using the described methods, we produced prototypes that were tested in the lab. Due to excessive suture induced damage such as insert point marking and tearing of the model even when used by expert surgeons, we felt that this technique was not a viable method of producing affordable high-fidelity vascular models that can be reused multiple times by the same participant. Thus, for the purposes of this take-home simulation kit, we included commercially available Penrose tubes and silicone casted tracheas. The Penrose tubing comes in 3 standard sizes and have been historically used for low fidelity simulation training [4]. The main limitation of the material is that it can stick to the nylon sutures. To address this issue, we use a small amount of petroleum jelly or mineral oil to make the tension and drag feel more realistic.

### Model Components: Trachea Segment Development

Although the model can be used for multiple surgical sub-specialties who perform anastomoses, our target audience was thoracic surgery trainees who must learn to perform the technique of tracheal anastomosis. To our knowledge, there are no commercially available models that simulate tracheal anastomosis. We have previously used porcine tracheas in our Thoracic Surgery Bootcamp [5], but these are only useful in a laboratory setting due to the limitations of using biological models (i.e. animal models). Thus, we attempted multiple techniques to create a bronchial anastomosis model for our take-home kit.

### Silicone Dip Spin Coating Technique

This technique has been previously implemented in the manufacturing of vessels for neurosurgery and cardiothoracic surgery simulation [6]. Both straight dipping and dip spin coating methods have been used to fabricate complex cardiovascular models with adherence to the mass production manufacturing standards. However, on a smaller scale manufacturing, this technique is time-consuming and not easily replicated in a lab setting.

The original manufacturing process tested for this simulator consisted of an iterative design approach. As the bronchus consists of cartilage rings on the anterior surface and a membranous posterior wall, we first attempted to use a combination of respiratory circuit tubing and 3D (Prusa i3MK3S+) printed PLA circular inserts to create the cartilaginous rings. The circular inserts represented tracheal rings and silicone with shore strength A30, A40, and A50 was used to encapsulate the rings inside the tubing. The major issue with the dip spin coating technique for silicone casting is that to control the even distribution of the silicone, the model needs to be extruded from the silicone at a specific rate and then continuously rotated while curing. Additionally, the silicone layering is very thin. To achieve an adequate thickness of the silicone coating that mimics the thickness of the bronchial wall, the coating needs to be repeated 3-4 times and adequate time must be provided between individual curing of the silicone layers.

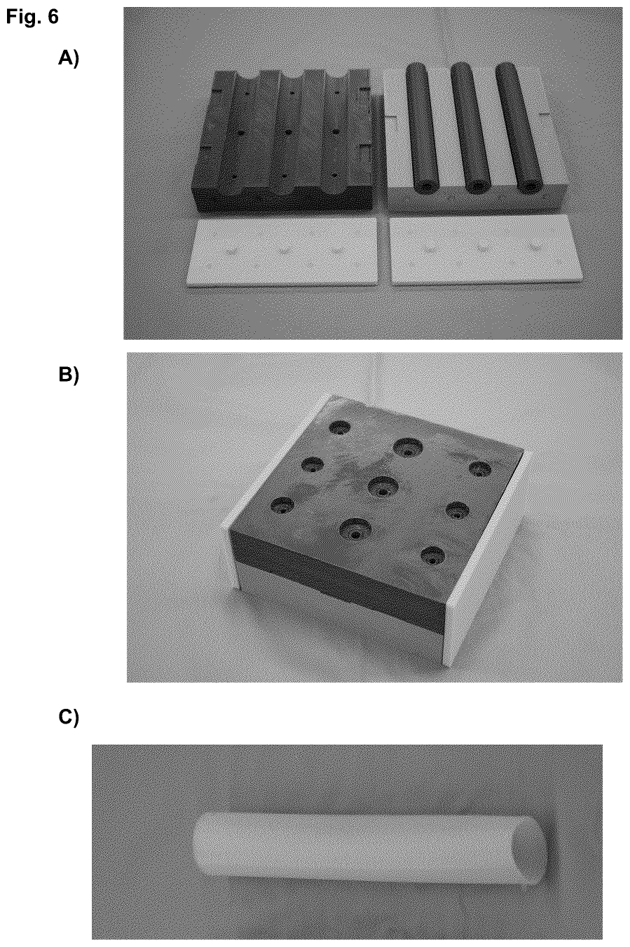

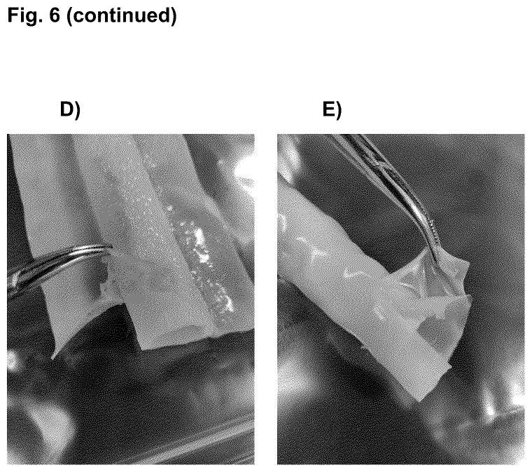

Complications associated with the control and even distribution of silicone material along the length of the tube can be addressed via an automated system that controls the speed of the dipping, extraction, spinning, and curing process [6]. A non-automated alternative is labor-intensive and not easily scalable. The preliminary models manufactured with this technique were tested by trainces and feedback regarding material quality was accumulated for future modifications. Trainees have commented on the shore strength of silicone and the rigidity of the 3D-printed PLA trachea rings (FIG. 6). It is important to note that PLA does not bond with silicone, which presents a unique challenge in the design of multi-material simulators. This experience led us to consider a completely different approach to design and manufacturing.

### Silicone Injection Molding Process

Injection molding with liquid silicone rubbers (LSR) materials is a well-documented process used in custom and mass-production manufacturing. Otherwise known as liquid injection molding (LIM), this process is advantageous in product design in that it allows for a high level of customizability and a fast turn-around time for modifications. Commonly used in the design and development of medical products, this technique is relatively low cost and is well suited for large scale production after design validation [7].

The process implemented in our study followed six production steps: (1) mold design and manufacturing, (2) mold assembly, (3) elastomer mixing & injection, (4) curing and demolding, (5) secondary elastomer mixing and injection, and (6) final demolding and clean-up.

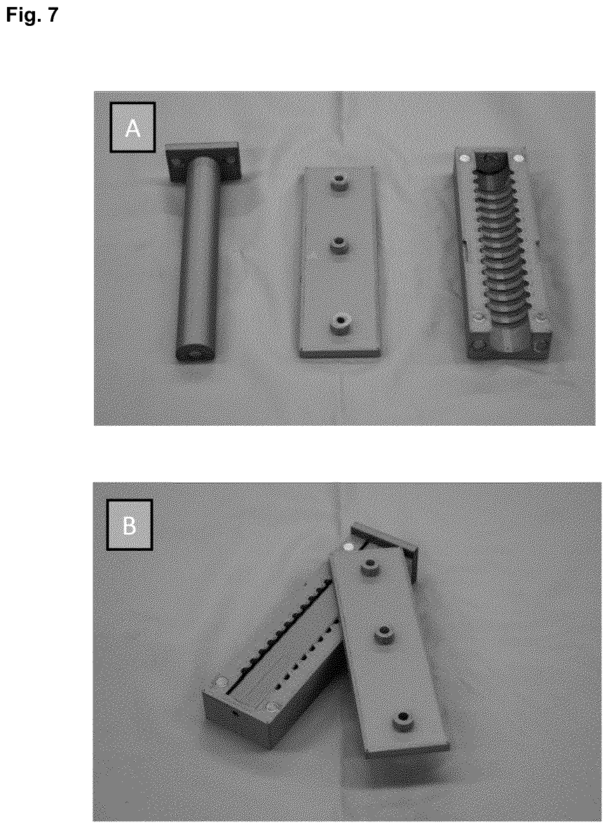

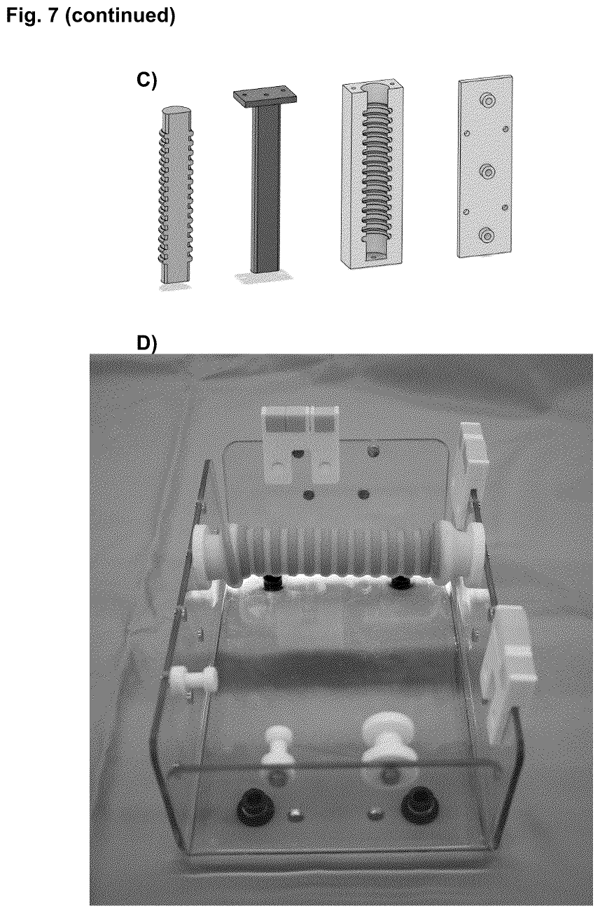

Mold design for the trachea started with the mold master file that was designed in computer-aided design (CAD) software Fusion360 (Autodesk). The final design consisted of a mold that was based on the measurements collected from the respiratory circuit used in the silicone dip spin technique model, and patient specific anatomic reconstruction. Additionally, the distance between bronchial rings was adjusted to mirror human anatomy more precisely [2]. The ring shape was also adjusted to mimic the C-shape of the bronchial rings. Positive and negative mold pieces were designed to be suitable for two-step casting with interchangeable positive mold pieces used to create the bronchial rings and bronchial wall. All mold pieces were 3D printed on Fused Deposition Modeling (FDM) Prusa i3 MK3S+ cartesian coordinate printer with PLA filament (FIG. 7).

Prior to the assembly, all parts were coated with mold release spray (EaseRelease200™) and assembled with screws and sealing glue. Two types of silicones were mixed. The bronchial rings were made from SORTA-Clear™ 40 rubber (Smooth-On) and bronchial wall was made with EcoFlex™ 00-20 FAST platinum cure rubber silicone (Smooth-On).

Elastomer mixing involved combining parts A and B of the raw active ingredients used to initiate the reaction that results in different types of EcoFlex™ materials and degassing with a pressurized vacuum chamber to remove potential void spaces in the material [7]. Next, the elastomer injection was performed via pressure-driven filling of the mold with help of a 100 cc plastic syringe, followed by elastomer curing that takes anywhere from 1 to 16 hours for EcoFlex™ 00-20 and SORTA-Clear™ 40 respectively.

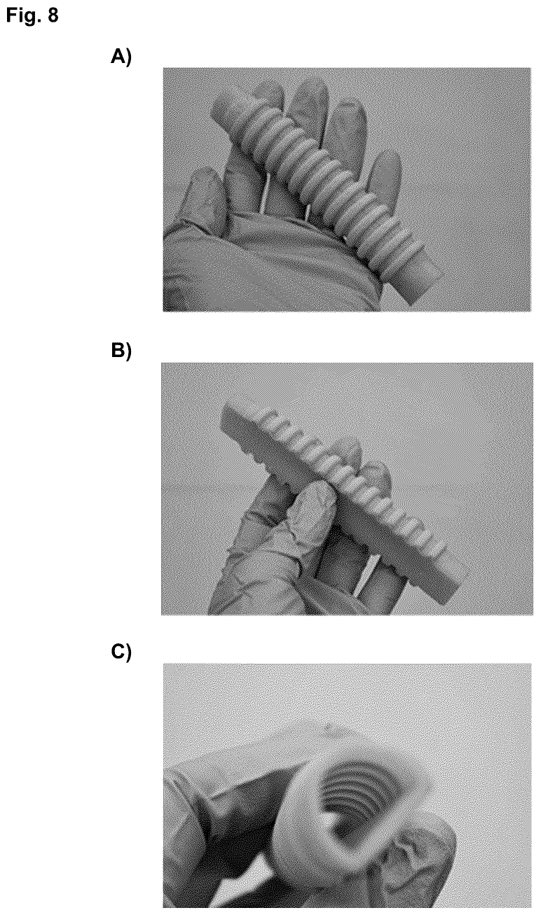

Once cured, the mold was disassembled, and the positive internal mold was swapped for a slimmer diameter insert. The casting process was then repeated to finish off the bronchial wall molding with EcoFlex™ 00-20 FAST mixed with a silicone pigment die (Silk Pig™). After the complete cure, the mold was released, and any excess material was cleaned from the model (FIG. 8). The process is replicable and scalable as molds can easily be reprinted as needed. Additionally, the amount of silicone injected with a syringe was significantly less compared to the dip spin coating technique that we tested originally. Overall, this has proved to be a flexible and modifiable process of bronchial design.

### Module Assembly: Bill of Materials

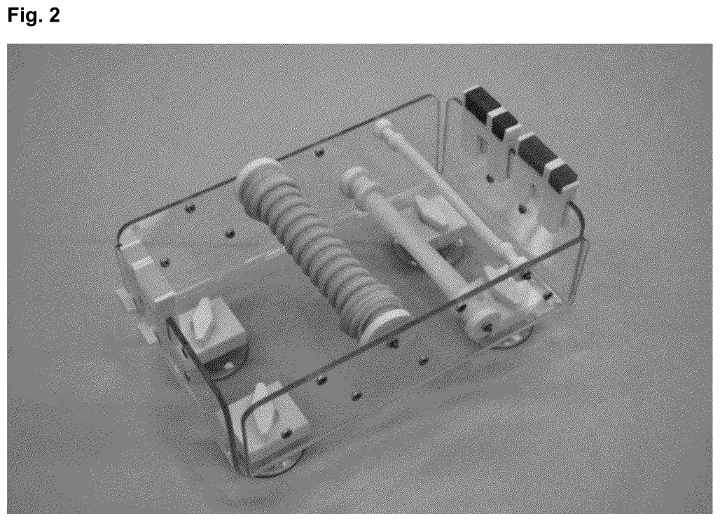

Each module was assembled in preparation for the user experience testing. A single module consisted of 1 plastic base, four 3D printed PLA supports used to attached suction cups so that the model can be stabilized while in use, 12 mounting pegs of 3 assorted sizes with a set of pegs that had a channel (see FIG. 5, C) used to perform a water tightness test on the anastomosis of the vessel, three sets of Penrose drain tubes (9 tubes) and one set of silicone tracheas (2 units) (FIG. 2). A side channel on mounting peg allows users to use a syringe filled with water to test the quality of anastomosis. After the completion of the exercise, a water filled syringe is used to push the water through the side channel of the peg into the vessel to fill the vessel (vascular or trachea segment) with water. A detected leak around the area of anastomosis indicates poor quality.

### Results and Data

An in-person training session was held during the Interventional Thoracic Surgery Training Course in Toronto. A total of 10 senior thoracic surgery residents and fellows were in attendance. Trainees had the opportunity to use our simulation box and models and provide an assessment by completing a 5-point Likert Scale User Experience (UX) questionnaire to rate their experience with the models. They were initially given instruction on the technique of performing an end-to-end vascular anastomosis and a bronchial anastomosis on a porcine model by an experienced lung transplant surgeon. After 20 minutes of practice time on the porcine model, the trainees had an opportunity to practice on the simulation box and were given feedback by the expert surgeon throughout.

All 10 participants had an opportunity to try out the module and complete at least one pulmonary artery and bronchial anastomosis. The overall experience was rated highly with minor feedback provided regarding the set-up and material qualities. Overall, the trainees agreed that the model was suitable for teaching advanced anastomosis techniques and expressed interest in being able to use this model to practice skill development remotely. The Penrose material used to simulate pulmonary artery was rated highly but was not felt to be as similar to a real tissue as desired. The sutures did not glide easily through the Penrose material and had to be coated in mineral oil to ensure uninhibited suturing technique. The silicone bronchus, on the other hand, proved to be remarkably like real tissue. Also, we found that the silicone was quite robust and could be reused multiple times. Trainees expressed interest in the use of this module for practice and have agreed that they would recommend it to their colleagues (FIG. 9).

### Vascular Anastomosis Study Participant Data

A total of 9 participants were recruited. Participants were thoracic surgery fellows with limited or no prior experience in the pulmonary artery vascular anastomosis. All participants were invited to attend an in-person training session at hospital and their performance was evaluated after the training session. The participants were then asked to complete 10 training sessions independently at home. For the final evaluation, participants returned to hospital to perform an anastomosis for further assessment.

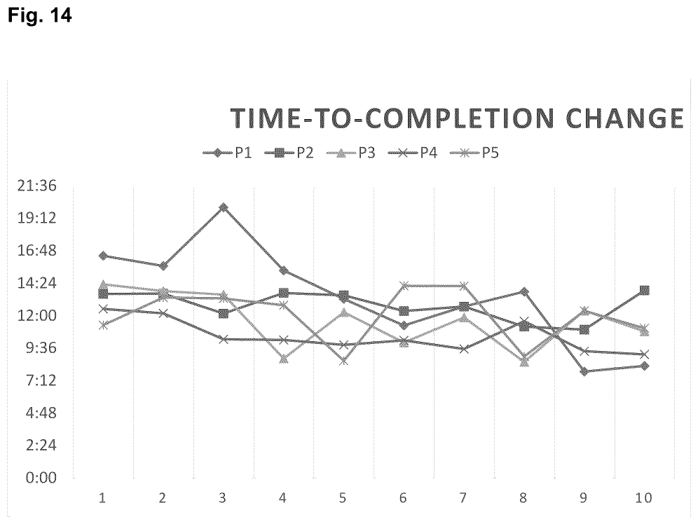

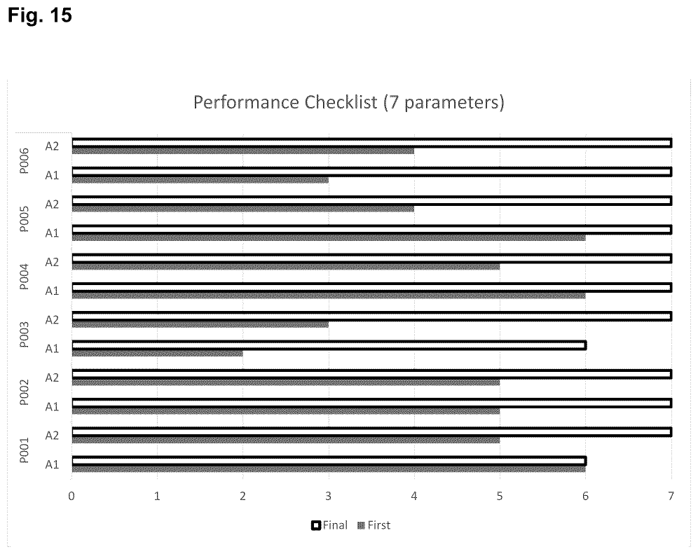

Consecutive repetition from the training sessions resulted in reduction of estimated-time-to-completion (see FIG. 14). The participants were evaluated on 7 parameters: 1) Placement of corner stitches, 2) Adequate distance between stitches, 3) Adequate stitch distance from the tissue edge, 4) Appropriate stitch size correction to account for size mismatch, 5) Secure corner stitches appropriately, 6) Water-tight seal, and 7) Avoidance of purse-stringing of completed anastomosis. As shown in FIG. 15, improvements were seen between first and final assessments. Data shown is from 6 participants who performed both assessments.

The participants showed an improved overall impression of ability, and also showed improved trustworthiness for independent task completion (data not shown). The participants reported positive experience and high satisfaction with portability and accessibility of the simulation kit. Upon the completion of the Pulmonary Anastomosis study all participants demonstrated an ability to complete a watertight anastomosis.

### Commentary

The importance of teaching technical skills outside of the operating room has been clearly recognized as a priority in medical education, as is evidenced by the multitude of literature published on this topic. The education of very senior learners, training in a surgical subspeciality after being certified as a competent surgeon, has been focused on much less than the training of junior learners [8,9,10]. For the junior trainees, a basic low-fidelity model with very little similarity to the characteristic of real tissues may be adequate to teach basic skills, yet this no longer will suffice for very experienced trainees. While senior fellows generally have a high level of anatomical understanding and competence, their skill retention and development with remotely accessible tools may significantly improve their skills in the operating room. Also, in the current era of work-hour restrictions, burnout, and limitations of available materials based on shortages caused by the Covid-19 pandemic, it has become increasingly important to develop easily reproducible models that mimic real tissues and can be used when the learners have time available in their schedules. Based on the earlier success of the module that was deployed for remote skill development as reported by Chan et al. [1], we wanted to further develop and refine the vascular anastomosis model and develop the bronchial anastomosis model.

Encouraged by the feedback received and recommendations provided by the participating trainces, we plan to conduct a skill development training and assessment study that will quantify the effectiveness of the proposed module for an on-site and offsite application. As stated by B. Marshall, et al [11], formal validation of simulation models is critical to their use in education.

There have been several papers published on models that are currently available in a form of commercial product or detailed reports on design and manufacturing techniques of surgical simulation models. Notably, the Thoracic Surgery Directors Association has been focusing on providing access to take-home simulation tools, like the Chamberlain croup coronary anastomosis pocket simulator [12]. The study concludes that access to remote practice, paired with mentorship guidance leads to (a) improved confidence, (b) performance, as well as (c) reduced time to completion amongst trainees.

The take-home and do-it-yourself trend has continued to be predominant in the cardiothoracic surgical skill acquisition space and led to establishment of contests where participants were asked to build their own simulators [13]. This approach showed that direct engagement forced participants to get creative and allowed them to indulge in a self-directed learning. Interestingly, the concept of high and low fidelity simulation comes up in the context of self-directed and guided learning. The key takeaway is that the fidelity is directly affected by the number of complementary resources and tools that are supplied with the simulator and guidance that is provided along the training process and towards the assessment and evaluation practice [13].

Similarly, to the cardiothoracic surgery, general surgery has been focusing its efforts on the development of high and low fidelity simulators that range from 3D printed to silicone molded bowels [15, 16]. Notably, the report on the hand sewn bowel anastomosis (HSBA) showed promising results and increased training satisfaction amongst trainees that had a chance to evaluate the model. In line with previously mentioned challenges, their group also found that the purely silicone cast bowel ripped under suture tension and lacked realism, concluding that an imbedded meshing may need to be considered to improve the versatility, reusability, and quality of the simulation [15].

Further analysis and testing need to be performed to fully assess the feasibility and function of the proposed simulation module. The key limitation of our simulation module now pertains to the materials such as Penrose drains. This includes the lack of realism as perceived by the trainees that had an opportunity to practice suturing on the Penrose drains. While the suture drag noted with use of the Penrose can be addressed with light coating of the suture with mineral oil or petroleum jelly, we believe that a higher fidelity model is more likely to be manufactured with a highly pliable mesh-like foundation embedded in a silicone core. Lastly, the tracheal rings rigidity and positioning may be adjusted to improve the fidelity of the model.

Based on the collected feedback, we plan to make modifications to the materials included in the module. Our future study will evaluate efficacy of the module with an in-person and remote training options. Concurrently, we are working on the development of the evaluation tools that will provide us with the insight on skill acquisition and mastery within a senior trainee participant population. One of the tools will be automated, meaning that a machine learning algorithm and python-based analysis will be used to monitor performance over time based on a video recording. We hypothesize that unlike with the evaluation of skill acquisition with medical students, higher level training requires specialized assessment tools and specialized supportive materials.

### CONCLUSIONS

The simulation box that we have developed has been shown to be easily reproducible, with models that accurately simulate real-life vascular and bronchial anastomoses for senior trainees. This simulation box may become an important method of training technical skills outside of the operating room for all levels of learners, with increasing task-complexity and possibility of standardized assessment.

### EMBODIMENTS

Embodiment 1. A kit for anastomoses simulation and training, the kit comprising: an open box having a perimeter wall and a base defining an interior space, the perimeter wall having a plurality of anchor points; one or more tubing for simulation of a tubular bodily vessel; a plurality of coupling means configured to couple to the plurality of anchor points and to suspend the one or more tubing within the interior space from a first anchor point to a second anchor point.

Embodiment 2. The kit of embodiment 2, wherein the perimeter wall comprises two sets of opposing walls.

Embodiment 3. The kit of embodiment 1 or 2, wherein the open box is transparent.

Embodiment 4. The kit of any one of embodiments 1-3, wherein the open box is formed from an acrylic sheet.

Embodiment 5. The kit of embodiment 2, wherein the plurality of anchor points comprise pairs of anchor points, wherein each pair of anchor points are located in corresponding positions on the opposing walls.

Embodiment 6. The kit of embodiment 2, wherein all the opposing walls have anchor points.

Embodiment 7. The kit of any one of embodiments 1-6, wherein the plurality of anchor points are positioned at various depths in the open box.

Embodiment 8. The kit of any one of embodiment s 1-7, wherein the plurality of anchor points comprise a plurality of spaced apart insert holes, and wherein the plurality of coupling means comprise a plurality of pegs.

Embodiment 9. The kit of embodiment 8, wherein the plurality of pegs each comprise a first end for removable attachment to the plurality of insert holes, and a second end for insertion into the lumen of the one or more tubing.

Embodiment 10. The kit of embodiment 9, comprising a plurality of tubing having different diameters, and wherein the second ends of the plurality of pegs are sized for insertion into the lumen of the plurality of tubing.

Embodiment 11. The kit of embodiment 10 for adjustably mounting the plurality of pegs and tubing based on a desired complexity of anastomoses simulation and training.

Embodiment 12. The kit of any one of embodiments 1-11, wherein the one or more tubing comprise a Penrose tube.

Embodiment 13. The kit of any one of embodiments 1-12, wherein the one or more tubing comprise a silicone tube for simulating a tracheal or bronchial segment.

Embodiment 14. The kit of any one of embodiments 1-13, wherein the base of the open box comprise mounting attachments for secure mounting of the open box to a surface.

Embodiment 15. The kit of embodiment 14, wherein the mounting attachments comprise suction attachments.

Embodiment 16. The kit of any one of embodiments 1-15, further comprising one or more suture holding pad, the one or more suture holding pad configured for removable attachment to the perimeter wall of the open box.

Embodiment 17. A method of manufacturing a silicone tracheal or bronchial segment for use in anastomoses simulation and training, the silicone tracheal or bronchial segment having a tubular wall and a plurality of semi-circular rings disposed along one exterior side of the tubular wall, the method comprising: providing a mold based on a human tracheal or bronchial segment, the mold having a tracheal ring compartment and a bronchial wall compartment; providing a first silicone mixture and injection molding same into the tracheal ring compartment; curing the first silicone mixture; providing a second silicone mixture and injection molding same into the bronchial wall compartment with the cured first silicone mixture; and curing the second silicone mixture.

Embodiment 18. The method of embodiments 17, comprising providing the mold based on patient-specific tracheal or bronchial anatomy.

Embodiment 19. The method of embodiment 18, comprising providing the mold based on i) dimensions and parameters collected from patient-specific tracheal or bronchial anatomy and ii) desired complexity of anastomoses simulation and training.

Embodiment 20. The method of any one of embodiments 17-19, wherein the first silicone mixture has a greater stiffness than the second silicone mixture when cured.

Embodiment 21. The method of any one of embodiments 17-20, wherein the first and second silicone mixtures comprises liquid silicone rubbers.

Embodiment 22. The method of any one of embodiments 17-21, wherein the first silicone mixture comprise a silicone rubber having shore strength of 30 A to 50 A when cured, preferably 40 A.

Embodiment 23. The method of any one of embodiments 17-22, wherein the second silicone mixture comprise a soft platinum cure silicone.

Embodiment 24. A silicone tracheal or bronchial segment for use in anastomoses simulation and training and made by the method of any one of embodiments 17-23.

Embodiment 25. A silicone tracheal or bronchial segment for use in anastomoses simulation and training, the silicone tracheal or bronchial segment having a tubular wall and a plurality of semi-circular rings disposed and aligned along one exterior side of the tubular wall, wherein the plurality of semi-circular rings are made from a silicone mixture having greater stiffness than the tubular wall.

Embodiment 26. The silicone tracheal or bronchial segment of embodiment 25, wherein the plurality of semi-circular rings are made from a silicone rubber having shore strength of 30 A to 50 A, preferably 40 A.

Embodiment 27. The silicone tracheal or bronchial segment of embodiment 26, wherein the plurality of semi-circular rings are made from SORTA-Clear™ 40 rubber.

Embodiment 28. The silicone tracheal or bronchial segment of any one of embodiments 25-27, wherein the tubular wall is made from a soft platinum cure silicone.

Embodiment 29. The silicone tracheal or bronchial segment of embodiment 28, wherein the tubular wall is made from EcoFlex™ 00-20 FAST platinum cure rubber silicone.

Embodiment 30. A method of manufacturing a silicone vascular segment for use in anastomoses simulation and training, the silicone vascular segment having a primary silicone tubular wall and a secondary silicone and wool fiber outer layer cured along an exterior of the silicone tubular wall, the method comprising: providing a mold based on human vascular segment anatomy, the mold comprising a tubular inner core piece and a tubular outer wall piece defining a space there between; providing a first silicone mixture and injection molding same into said space; curing the first silicone mixture to form the primary silicone tubular wall; providing a second silicone mixture comprising wool fibers and dip-spin-coating the exterior of the silicone tubular wall with said second silicone mixture; and curing the second silicone.

Embodiment 31. The kit of embodiment 9, wherein the plurality of spaced apart insert holes have magnetic inserts inserted therein, and wherein the first end comprise magnetic bases.

Embodiment 32. The kit of embodiment 9, wherein some of the plurality of pegs each comprise a side channel in fluid communication with the lumen of the one or more tubing when inserted on said pegs, and with an opening configured to receive fluid injection.

### REFERENCES

[1] Chan, Justin C Y, et al. “Maintaining technical proficiency in senior surgical fellows during the COVID-19 pandemic through virtual teaching.” Jtevs Open 8 (2021): 679-687. (Chan et al., 2020).
[2] Boice, Emily N., et al. “Development of a Modular Tissue Phantom for Evaluating Vascular Access Devices.” Bioengineering 9.7 (2022): 319.
[3] Peel, Brandon, et al. “State-of-the-art silicone molded models for simulation of arterial switch operation: Innovation with parting-and-assembly strategy.” JTCVS techniques 12 (2022): 132-142.
[4] Amirian, Michael J., et al. “Surgical suturing training with virtual reality simulation versus dry lab practice: an evaluation of performance improvement, content, and face validity.” Journal of Robotic Surgery 8.4 (2014): 329-335.
[5] Schieman, Colin, et al. “General thoracic surgical training in North America: contrasting general thoracic surgery residencies in Canada and the United States.” The Journal of Thoracic and Cardiovascular Surgery 156.6 (2018): 2379-2387.
[6] Cortez, Miguel A., Rolando Quintana, and Ryan B. Wicker. “Multi-step dip-spin coating manufacturing system for silicone cardiovascular membrane fabrication with prescribed compliance.” The International Journal of Advanced Manufacturing Technology 34.7 (2007): 667-679.
[7] Chung, Philip, et al. “Rapid and low-cost prototyping of medical devices using 3D printed molds for liquid injection molding.” JoVE (Journal of Visualized Experiments) 88 (2014): e51745.
[8] Boutefnouchet, Tarek, and Thomas Laios. “Transfer of arthroscopic skills from computer simulation training to the operating theatre: a review of evidence from two randomised controlled studies.” SICOT-J 2 (2016).
[9] Egle J P, Malladi S V, Gopinath N, Mittal V K. Simulation training improves resident performance in hand-sewn vascular and bowel anastomoses. J Surg Educ. 2015; 72 (2): 291-6.
[10] Waterman, Brian R., et al. “Simulation training improves surgical proficiency and safety during diagnostic shoulder arthroscopy performed by residents.” Orthopedics 39.3 (2016): e479-e485.
[11] Marshall, M. Blair. “Simulation for technical skills.” The Journal of thoracic and cardiovascular surgery 144.3 (2012): S43-S47.
[12] Anand, Jatin, et al. “Coronary anastomosis simulation: directed interventions to optimize success.” The Annals of Thoracic Surgery 111.6 (2021): 2072-2077.
[13] De Raet, Jan M., et al. “How to build your own coronary anastomosis simulator from scratch.” Interactive cardiovascular and thoracic surgery 16.6 (2013): 772-776.
[14] Habti, Merieme, et al. “Development and Learner-Based Assessment of a Novel, Customized, 3D Printed Small Bowel Simulator for Hand-Sewn Anastomosis Training.” Cureus 13.12 (2021).
[15] Oxford, Katie, et al. “Development, manufacture and initial assessment of validity of a 3-dimensional-printed bowel anastomosis simulation training model.” Canadian Journal of Surgery 64.5 (2021): E484.

1. A kit for anastomoses simulation and training, the kit comprising:
an open box having a perimeter wall and a base defining an interior space, the perimeter wall having a plurality of anchor points;
one or more tubing for simulation of a tubular bodily vessel;
a plurality of coupling means configured to couple to the plurality of anchor points and to suspend the one or more tubing within the interior space from a first anchor point to a second anchor point.

2. The kit of claim 1, wherein the perimeter wall comprises two sets of opposing walls.

3. The kit of claim 1, wherein the open box is transparent.

4. The kit of claim 1, wherein the open box is formed from an acrylic sheet.

5. The kit of claim 2, wherein the plurality of anchor points comprise pairs of anchor points, wherein each pair of anchor points are located in corresponding positions on the opposing walls.

6. The kit of claim 2, wherein all the opposing walls have anchor points.

7. The kit of claim 1, wherein the plurality of anchor points are positioned at various depths in the open box.

8. The kit of claim 1, wherein the plurality of anchor points comprise a plurality of spaced apart insert holes, and wherein the plurality of coupling means comprise a plurality of pegs.

9. The kit of claim 8, wherein the plurality of pegs each comprise a first end for removable attachment to the plurality of insert holes, and a second end for insertion into the lumen of the one or more tubing.

10. The kit of claim 9, comprising a plurality of tubing having different diameters, and wherein the second ends of the plurality of pegs are sized for insertion into the lumen of the plurality of tubing.

11. The kit of claim 10 for adjustably mounting the plurality of pegs and tubing based on a desired complexity of anastomoses simulation and training.

12. The kit of claim 1, wherein the one or more tubing comprise a Penrose tube.

13. The kit of claim 1, wherein the one or more tubing comprise a silicone tube for simulating a tracheal or bronchial segment.

14. The kit of claim 1, wherein the base of the open box comprise mounting attachments for secure mounting of the open box to a surface.

15. The kit of claim 14, wherein the mounting attachments comprise suction attachments.

16. The kit of claim 1, further comprising one or more suture holding pad, the one or more suture holding pad configured for removable attachment to the perimeter wall of the open box.

17. A method of manufacturing a silicone tracheal or bronchial segment for use in anastomoses simulation and training, the silicone tracheal or bronchial segment having a tubular wall and a plurality of semi-circular rings disposed along one exterior side of the tubular wall, the method comprising:
providing a mold based on a human tracheal or bronchial segment, the mold having a tracheal ring compartment and a bronchial wall compartment;
providing a first silicone mixture and injection molding same into the tracheal ring compartment;
curing the first silicone mixture;
providing a second silicone mixture and injection molding same into the bronchial wall compartment with the cured first silicone mixture; and
curing the second silicone mixture.

18. A silicone tracheal or bronchial segment for use in anastomoses simulation and training and made by the method of claim 17.

19. A silicone tracheal or bronchial segment for use in anastomoses simulation and training, the silicone tracheal or bronchial segment having a tubular wall and a plurality of semi-circular rings disposed and aligned along one exterior side of the tubular wall, wherein the plurality of semi-circular rings are made from a silicone mixture having greater stiffness than the tubular wall.

20. The kit of claim 9, wherein the plurality of spaced apart insert holes have magnetic inserts inserted therein, and wherein the first end comprise magnetic bases.

21. The kit of claim 9, wherein some of the plurality of pegs each comprise a side channel in fluid communication with the lumen of the one or more tubing when inserted on said pegs, and with an opening configured to receive fluid injection.
